(19) United States
(12) Patent Application Publication
(10) Pub. No.: US 2024/0116744 A1
(43) Pub. Date: Apr. 11, 2024

(54) LIQUID DISTRIBUTION SYSTEM

(71) Applicant: G.A.I.N Venture Studios Ltd, Nicosia (CY)

(72) Inventor: Antonis Neocleous, Larnaca (CY)

(21) Appl. No.: 17/962,512

(22) Filed: Oct. 9, 2022

(51) Int. Cl. B67D 7/08; B67D 7/02; B67D 7/22; B67D 7/74; B67D 7/78

(52) U.S. Cl. CPC B67D 7/08; B67D 7/02; B67D 7/221; B67D 7/74; B67D 7/78

(57) ABSTRACT

This application is directed to a consumer liquid necessities distribution system. The system includes piping networks to deliver the various desired liquid necessities from a central bulk liquid storage station directly to the consumer in a trackable manner. The liquid distribution system includes a central bulk storage station, a piping network, a central data receiving and processing server, and a dispensing system for dispensing the liquid through one or more dispensing points.

### FIELD

This application relates to a liquid distribution system. In particular, this applications relates to distribution of liquids or viscous products by smart pipe-line systems.

### BACKGROUND

Some of the most prevalent plastics utilized in primary packaging of liquids belong to the thermoplastics family of polymers and include Polyethylene Terephthalate (PTE), High-Density Polyethylene (HDPE) and Low-Density Polyethylene (LDPE). These materials are also the biggest contributors to the plastics used in the general packaging sector and cumulatively make up approximately 70% of the total. Consumer liquid necessities for hygienic and cleaning purposes can be categorized in personal hygiene liquids (e.g., soaps, shampoos etc.), clothing care liquids (softeners, detergents etc.), household or industrial care liquids (cleaning agents for floor, glass etc.) and public health hygiene liquids (pesticides, disinfectants etc.). These categories serve both private & industrial end-users.

The production of plastics has increased from 1.5 Mt in 1950 to 367 Mt today. Apart from the fact that the majority ˜99% of primary plastics are derived from fossil fuels, the biggest challenge faced by the global community today is the end-of-life management of these materials. The waste produced globally in 2019 was approximately 353 Mt with only a fraction of 9% of the waste being recycled and the rest ending up in landfills, are incinerated or mismanaged/uncollected. The latter leading to an escape or “leakage” of plastic from the desired closed-loop system. The contribution of the packaging sector to the worldwide production of plastics today is the highest amongst all sectors utilizing plastics, at approximately 40%. In combination with the relatively short “in-use” lifecycle of packaging, the waste production of packaging is also the highest, at around 95% compared to the other sectors, totaling at 142 Mt

Various approaches have been employed to minimize plastic waste. Specifically, post-consumer waste has been targeted to minimize its large contribution to the plastics waste problem. Some of the main approaches employed are discussed below.

One of the most pursued methods of dealing with the issue of plastic waste packaging is recycling. Recycling is a means of creating circularity in the lifecycle of plastics by reintroducing material as feedstock (secondary plastics) to minimize the need to produce new virgin materials, thus “closing the loop”. However, recycling is a cumbersome process which requires several resources to act in a coordinated manner. Each step of the process faces its own challenges.

The collection process can be separated into two phases: Amassing the post-consumer plastic waste and transportation to processing stations. Various approaches are implemented which require the consumer to either take the plastic waste to specific collection point (Bring-scheme) or through curbside collection. These approaches both rely heavily on highly committed public behavior and a Bring-scheme will not be as effective without certain economic incentives in place to benefit the consumer. The second part of the collection process is the picking-up of the post-consumer waste to be delivered to the sorting and processing stations. This requirement significantly contributes to the cost of the collection process and to CO2 emissions, because of the transportation means required to carry out the process

The next phase of recycling is the sorting of the plastic post-consumer waste by plastic type. The process can be carried out by both automatic and manual methods. Separation of plastics by type, color, shape, and/or texture requires specialized equipment such as optical sorters and/or artificial intelligence (AI)-equipped sorters. This of course translates to large initial investment costs. Many facilities still rely on manual sorting to achieve high purity levels. This can be expensive and time-consuming for high volumes of waste, and it endangers operators' health due to toxic additives.

Depending on the desired quality, the treatment (chemical or mechanical) of the recycled plastics for re-introduction to the lifecycle results in a final product that is volatile both economically and quality wise. Good quality recycled plastics usually demand 60 to 70% of the price of the corresponding virgin resin though that price can drop dramatically as properties are lost. There needs to be some finite difference between the cost to recover and the price the product can demand for recycling a particular resin by a given process to be economically viable. The economics of plastic recycling become less favorable as the commodity pricing of virgin resins falls. Up to 70% of the cost to synthesize a resin is based on the cost of the fuel stock, depending on the process used. The shale gas boom results in the plastics industry having access to significant quantities of a less-expensive feedstock. The cost of energy used to synthesize resin, also from natural gas sources, also is reduced by the availability of shale gas. As the cost to produce virgin plastics decreases, the pressures on the recycle market to further reduce the cost of their product is intensified.

Other solutions include providing bulk stores that offer products to the consumer by various manufacturers in bulk. The consumer then can bring their reusable containers or bags into the store. The system is mostly used for non-perishables and is limited to dry products such as cereals, nuts, candy etc. Dedicated dispensing systems of various liquids such as personal care and cleaning products are also available. However, bulk dispensers are usually avoided by retailers due to hygiene demands, as determined by industry standards.

Reuse packaging is a promising solution for reducing the post-consumer waste problem. More value is retained by product reuse than material recycling. Reuse of the packaging retains the functionality of the material and product and achieves potentially large reductions in material use and environmental impacts. Some of the types of reusable packaging solutions implemented today are briefly described below.

Refillable parent packaging is a solution offered by companies to consumers where products are offered in pouches which in turn are used to refill a reusable container. Another example of this system are concentrated solutions of products which can be dissolved by the consumer by mixing with water. The idea is to avoid bulk packaging since most liquid products are made up primarily of water. This reduces transport costs since the volume and weight of the product is reduced. The solution however still requires the need for plastic packaging and in most cases a combination of plastics is required to produce the pouches and caps.

Examples in the Business-to-Consumer market (B2C) are now limited. The general idea is for consumers to give back the packaging (e.g., glass bottles, cans) to the business that provided the product in the first place. The product company then reuses the packaging. However, the system does have leakages from consumers who do not return the packaging and most companies are now turning to single use packaging solutions.

Plastics that can degrade faster and more readily in the natural environment into carbon dioxide, water and biomass have been heavily investigated as they could curb the waste issue. These materials are front runners in replacing conventional petroleum-based plastics. One of the main challenges faced with biodegradable plastics are the different performance requirements such as mechanical properties, toxicity, moisture tolerance, and the low costs for both the starting materials and manufacturing technologies that must be met.

Biodegradable raw material production sustainability is also an issue. Biobased polymers such as PLA and PHA currently require starch and sugars for lactic acid fermentation. This requirement burdens the world's greatest starch and sugar plant resources. It is expected that approximately 10 million tons of sugar substrates will be required to substitute approximately 5% of the annual production of conventional plastics with PLA which with today's standards would draw into useful food sources.

Most of the current solutions mentioned above which are used today to minimize post-consumer plastic waste rely heavily on logistics. Additionally, the initial stage of providing the consumer with the packaged product at the local retailer also requires means of transportation. This is another aspect of the detrimental effects on the environment that plastic packaged goods and their waste cumulatively contribute.

### SUMMARY

This application aims at reducing the amount of plastics waste associated with consumer liquid packaging by reducing the initial need of the plastics to be produced in the first place. Simultaneously, it also aims at reducing the carbon footprint related to the logistics/distribution of these packaged consumer liquid necessities.

In one aspect of this application, a liquid distribution system is provided. The system includes a central bulk storage station. The central bulk storage station includes a first storage container. The first storage container contains a first liquid. The central bulk storage station includes a second storage container. The second storage container contains a second liquid. The central bulk storage station includes a flow information transmission system. The system also includes a piping network. The piping network is fluidly connected to the first and second storage container such that the first and second liquids flow into the piping network and are mixed together in the piping network. The flow information transmission system is in operative connection with the piping network to monitor flow information of the first and second liquid through the piping network. The liquid distribution system further includes a central server for receiving and processing data, and a dispensing system. The dispensing system is fluidly connected to the piping network. The dispensing system is operative to dispense the first and second liquids at one or more dispensing points. The central server is in operative connection with the flow information transmission system. The flow information transmission system is operative to transmit the flow information data of the first and second liquids through one of the dispensing points to the central server. The central server is operative to process the flow information data of the first and second liquids through the one of the dispensing points. The central server is operative to send the processed flow information data of the first and second liquids through the one of the dispensing points to a user device. The user device is operative to output a notification to the user of the first and second liquid consumption from the first and second containers dispensed at the one of the dispensing points based on the processed data.

In another aspect of this application, a liquid distribution system is provided. The liquid distribution system includes a central bulk storage station. The central bulk storage station includes a first storage container. The first storage container contains a first liquid. The central bulk storage station includes a flow information transmission system and a piping network. The piping network is fluidly connected to the first storage container. The flow information transmission system is in operative connection with the piping network to monitor flow information of the first liquid through the piping network. The liquid distribution system further includes a central server for receiving and processing data, and a dispensing system. The dispensing system is fluidly connected to the piping network. The dispensing system is operative to dispense the first liquid at one or more dispensing points. The central server is in operative connection with the flow information transmission system. The flow information transmission system is operative to transmit the flow information data of the first liquid through one of the dispensing points to the central server. The central server is operative to process the flow information data of the first liquid through the one of the dispensing points. The central server is operative to send the processed flow information data of the first liquid through the one of the dispensing points to a user device. The user device is operative to output a notification of the first liquid consumption from the first container dispensed at the one of the dispensing points based on the processed data. The central server includes a billing module. The billing module is operative to receive the first liquid consumption data dispensed at the dispensing point and charges a user based on the amount of consumption of the first liquid by the user at the dispensing point.

In another aspect of the present invention, a liquid distribution system is provided. The liquid distribution system includes a central bulk storage station. The central bulk storage station includes a first storage container. The first storage container contains a first liquid. The central bulk storage station includes a flow information transmission system. The liquid distribution system further includes a piping network. The piping network is fluidly connected to the first storage container. The flow information transmission system is in operative connection with the piping network to monitor flow information through the piping network. The liquid distribution system also includes a central server for receiving and processing data, and a dispensing system. The dispensing system is fluidly connected to the piping network. The dispensing system is operative to dispense the first fluid at one or more dispensing points. The central server is in operative connection with the flow information transmission system. The flow information transmission system is operative to receive data related to the flow parameters of the piping network. The flow information transmission system sends the received data related to the flow parameters of the piping network to the central server. The central server is operative to process and send the data related to the flow parameters of the piping network to a monitoring system. The monitoring system is operative to determine a fault based on the data related to the flow parameters of the piping network received from the central server.

Further embodiments of the disclosed liquid distribution system will become apparent from the following detailed description, the accompanying drawings and the appended claims.

### BRIEF DESCRIPTION OF THE DRAWINGS

FIG. 1 is a schematic diagram of a liquid distribution system according to one embodiment of the present invention;

FIG. 2 is a schematic diagram of a bulk liquid necessities storage system having primary and secondary storage tanks according to the liquid distribution system of FIG. 1;

FIG. 3 is a schematic diagram of a bulk liquid necessities storage system having multiple tanks according to the liquid distribution system of FIG. 1;

FIG. 4 is a schematic diagram of another embodiment of the liquid distribution system of FIG. 1 that includes a manifold to accommodate two users;

FIG. 5 is a schematic diagram of another embodiment of the liquid distribution system that has a piping system for multiple users;

FIG. 6 is a schematic diagram of a portion of the liquid distribution system that includes a venturi device for mixing an additive to a liquid for dispensing to a dispensing point;

FIG. 7 is a schematic diagram of another embodiment of the liquid distribution system of FIG. 1 that accommodates a cluster of multiple users;

FIG. 8 is a schematic diagram of another embodiment of the liquid distribution system of FIG. 1 that accommodates a super cluster of multiple users; and

FIG. 9 is a schematic diagram of a portion of the liquid distribution system of the present invention for maintaining the liquid distribution system.

### DETAILED DESCRIPTION

It will be readily understood that the components of the embodiments as generally described and illustrated in the figures herein, may be arranged and designed in a wide variety of different configurations in addition to the described example embodiments. Thus, the following more detailed description of the example embodiments, as represented in the figures, is not intended to limit the scope of the embodiments, as claimed, but is merely representative of example embodiments.

As used herein, the terms “component” and “system” are intended to encompass hardware, software, or a combination of hardware and software. Thus, for example, a system or component may be a process, a process executing on a processor, or a processor. Additionally, a component or system may be localized on a single device or distributed across several devices. The term “module” may refer to a hardware based module, software based module or a module that is a combination of hardware and software resources. A module (whether hardware, software, or a combination thereof) may be designed to implement or execute one or more particular functions, tasks or routines of the system. Embodiments of hardware based modules may include self-contained components such as chipsets, specialized circuitry and one or more memory devices. A software-based module may be part of a program code or linked to program code containing specific programmed instructions loaded in a memory device.

Furthermore, the described features, structures, or characteristics may be combined in any suitable manner in one or more embodiments. In the following description, numerous specific details are provided to give a thorough understanding of embodiments. One skilled in the relevant art will recognize, however, that the various embodiments can be practiced without one or more of the specific details, or with other methods, components, materials, etc. In other instances, well-known structures, materials, or operations are not shown or described in detail to avoid obfuscation. The following description is intended only by way of example, and simply illustrates certain example embodiments.

A smart and centralized consumer liquid necessities distribution system is provided. The system comprises piping networks to deliver the various desired liquid necessities from a central bulk liquid storage station directly to the consumer in a trackable manner without the need for packaging and delivery. The storage of the liquid necessities in bulk form, which can serve several users, eliminates the need of individually packed liquid necessities thus reducing the need for plastic packaging. Also, the piping distribution network deals with the issue of carbon dioxide emissions associated with the logistics of these packaged liquid necessities, as the carbon footprint is reduced only to the emissions related to the delivery required to the bulk storage station(s) which in their own right can be scaled according to the number of users being served.

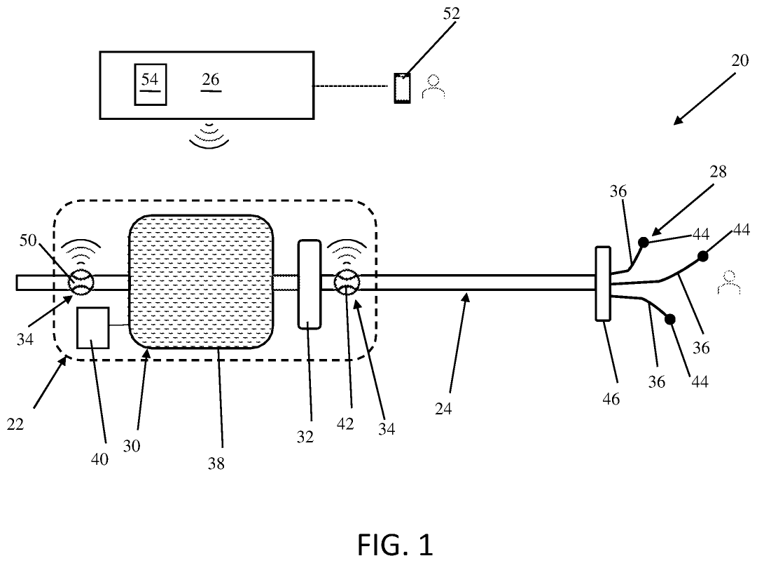

A simplified schematic of the proposed solution at its lowest level of scale (single user) for single liquid necessity delivery is depicted below in FIG. 1 to convey the general concept. The main components of the centralized liquid distribution system 20 comprise a central bulk storage station 22, a piping network 24, a central data receiving and processing server 26, and a dispensing system 28.

The central bulk storage station 22 includes a bulk liquid necessities storage system 30, a liquid distribution/delivery system 32 and a flow information and data transmission system 34. The piping network 24 serves to deliver the liquid necessities. The central data receiving and processing server 26 receives the flow information data and processes the data to track and inform an individual user of fluid consumption and other information about the system 20. The dispensing system 28 dispenses the liquid necessities at the user premises based on user needs through branch lines 36.

The bulk liquid necessities storage system 30 includes a storage tank 38 or other device that is filled with the desired bulk liquid necessity (e.g., detergent, soap, disinfected, cleaning agent etc.) through piping from a higher-level central station or by a filling service vehicle. The distribution/delivery system 32 pressurizes the liquid using a pump 40 or other mechanical device in operative connection with the central bulk storage station 22 to deliver the fluid to the user. The flow information and data transmission system 34 is in operative connection with the piping network 24 and is comprised of flow measurement/indicator components such as a flow meter 42 with data loggers that transmit (wired or wirelessly) the recordings to the central data receiving and processing server 26 where the data is processed and translated to useful information (e.g., specific user liquid consumption). The system 20 allows the “billing” of users based on the consumption. The central bulk storage station 22 can be stationary (e.g., built infrastructure), mobile (e.g., fitted on vehicle) or even portable (e.g., device).

The system 20 also includes the distribution of the liquid at various dispensing points 44 via suitable devices (e.g., washing machine, bathroom, kitchen sink tap, multi-dispenser etc.) that the user desires in their premises. The distribution of the liquid in the user's premises could be achieved through a distributor 46 (e.g., manifold) that allows several branching lines 36 to deliver the liquid at the desired locations or dispensing points 44. The user or even a house-hold device (e.g., washing machine) can draw liquid on-demand from the central bulk storage station 22 through the distribution system 32.

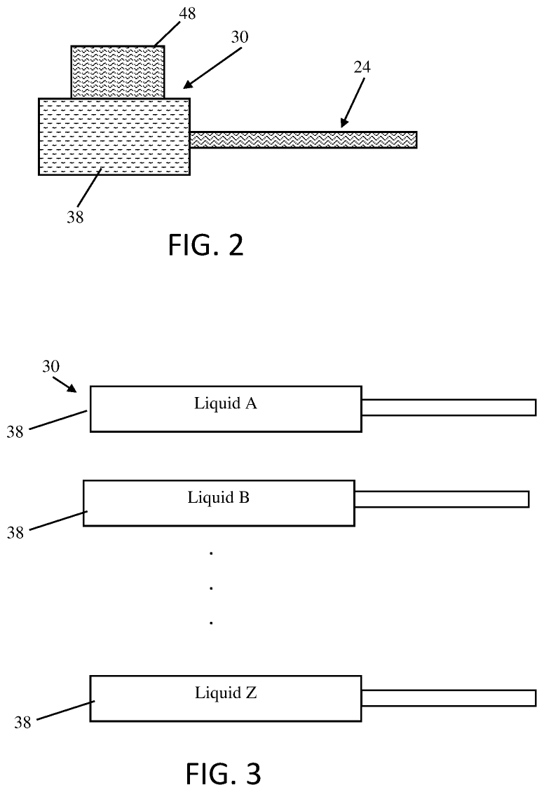

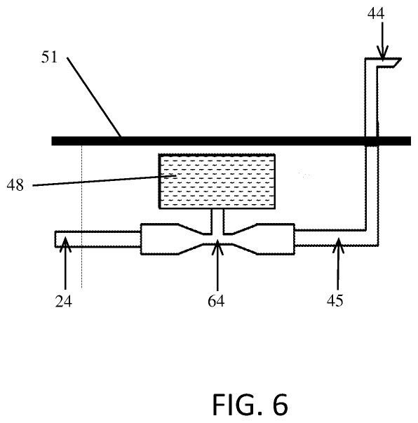

The bulk liquid necessities storage system 30 could be comprised of a single tank 38 (FIG. 1) or even multiple tanks 38 (FIG. 3) depending on the number of types of liquid necessities which are required to be stored for delivery. Also, combinations of storage tanks are possible to allow for a primary storage tank 38 to store a base type of liquid and a secondary tank 48 to store an additive as illustrated in FIG. 2. In particular, when the primary and secondary storage tanks 38, 48 content mix in the piping network 24, a final product 45 (FIG. 6) can be delivered to one or more dispensing points 44 for one or more users. An example of this can be in the case of liquid soap, where a soap base can be stored in a primary tank 38 and a specific scent (additive) can be stored in the secondary tank 48. In all other aspects, this distribution configuration is similar to that shown in FIG. 1.

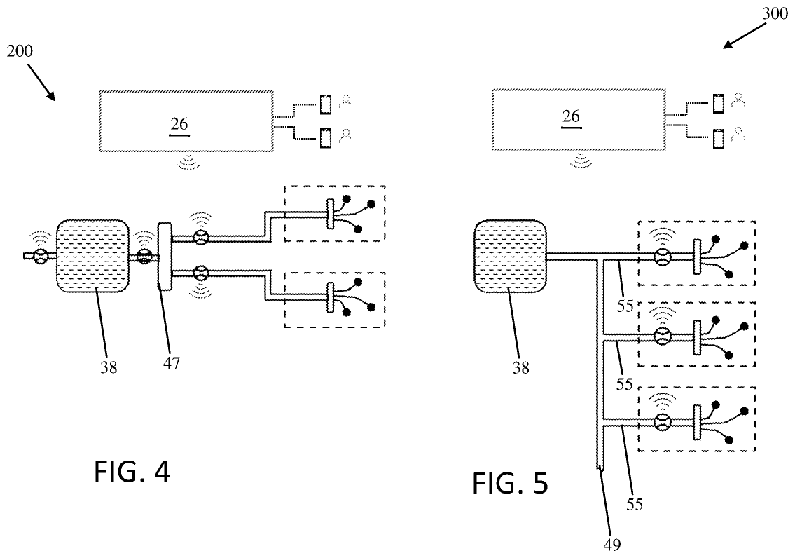

The distribution of the liquid from the central bulk storage station 22 could be achieved by directly connecting the bulk liquid necessities storage system 30 to the user premises by the piping network 24. In a distribution configuration 200 of the liquid distribution system 20 for multiple users, a manifold or header 47 at the central bulk storage station 22 can be utilized to handle the distribution of the fluid to each user separately as illustrated in FIG. 4. In all other aspects, this distribution configuration is similar to that shown in FIG. 1. In another distribution configuration 300 for multi-users, a piping arrangement having a central larger diameter pipe 49 with smaller pipes 55 branching off towards individual users may be provided as illustrated in FIG. 5. In all other aspects, this distribution configuration is similar to that shown in FIG. 1. The delivery of the liquid could be accomplished with a pressure producing device such as the pump 40 (FIG. 1) with user control capabilities or by stored potential energy created by elevating the storage system to an appropriate height above the dispensing points to enable the conversion of the potential energy of the stored fluid to dynamic fluid energy when it is required by the user. The control of the potential energy delivery system could be achieved by an electrically controlled valve.

The flow information transmission system 34 may include flow information or tracking devices such as flow meters 42 that could measure the amount of liquid flow at specific points of interest on the piping network 24. The flow measurement data could be sent to the server 26 either wirelessly or through a wired connection where it would be recorded and stored for further processing. Alternatively, the flow tracking device may be a flow indicator (I/O) 50 that shows whether the flow is present or not through a pipe. For example, flow tracking devices may be low cost flow indicators positioned at the specific points of interest on the piping network. Since the flow rate of a given system would be known, the recordings of the indicators could be sent to a server with processing capabilities that would calculate the flow rates at each point with high accuracy using algorithms (e.g., AI, machine learning etc.). Other flow related information such as the type of fluid could also be registered by the flow tracking devices or other devices during the filling stage of the central storage tank 38 which in turn is forwarded to the central server 26 so as to be recorded.

The central server 26 is in operative connection with the flow information transmission system 34. The flow information transmission system 34 is operative to transmit the flow information data of the liquid through one of the dispensing points to the central server 26. The central server 26 is operative to process the flow information data of the liquid through one of the dispensing points 44. The central server 26 is operative to send the processed flow information data of the liquid through the dispensing point 44 to a user device 52. The user device 52 is operative to output a notification of the liquid consumption from the container 38 dispensed at the dispensing point 44 based on the processed data. The central server 26 includes a billing module 54 that is operative to receive the liquid consumption data dispensed at the dispensing point 44 and charges a user based on the amount of consumption of the liquid by the user at the dispensing point 44.

The central server 26 processes the flow data to output valuable system information such as the fluid consumption by type per user, the user preferences etc. In this way, the user can be informed in real time, through access to an online platform, about their fluid necessities consumptions. Flow tracking for each individual user also allows for a “billing” scheme to be developed where each individual user is charged based on their liquid usage through the billing module 54. The billing module 54 receives the liquid usage from the user and charges the user based on the amount of the user's liquid usage. The general flow information allows for continuous optimization of the entire liquid necessities distribution system 32.

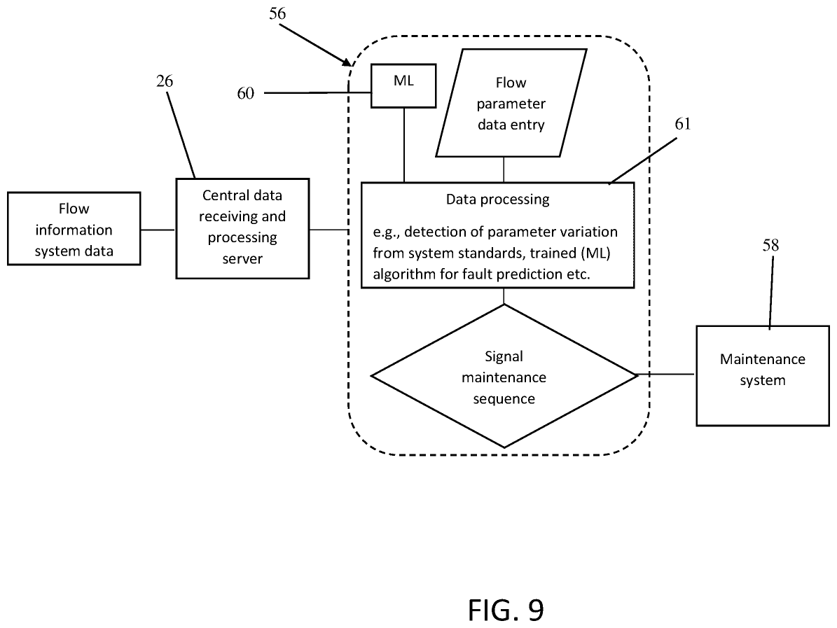

As illustrated in FIG. 9, the flow information and data transmission system 34 may provide the necessary data collection tools required for the implementation of a monitoring system 56 with fault (clogging, leakage etc.) detection/prediction capabilities. Based on the detected/predicted faults from this data, a maintenance system 58 is signaled to carry out a sequence of actions for the prevention or correction of a fault. In particular, the collected data from the flow information transmission system 34 can be used to detect changes in set (default) flow parameters of a given piping system by the monitoring system 56. The changes could be in flow rate, pressure, vibrations etc. in the piping system. Based on the type of changes detected, the monitoring system 56 informs a system operator of any variations that may indicate a fault in the piping system and/or signals for predefined automated maintenance actions based on the nature of the variations e.g., in the case of increased system pressure, and/or reduction in system flow rate, the system shuts off or decreases pump pressure etc.

Additionally, the monitoring system 56 has the capability of processing the collected data using algorithms (e.g., AI, machine learning etc.) to perform predictions based on these variations. In this case even slight variations in flow parameters could be used to predict a possible future fault before it is in full effect e.g., accumulation of residue on pipe walls that may lead to future clogging or evidence of small leakage (drops) that may lead to bigger leakage. In this case, advanced preventive maintenance actions can also be employed e.g., in the case of possible accumulation of residue in pipe, high and abrupt pressure (spike) sequence may be initiated to flush the system and clear any accumulation. FIG. 9 illustrates this process. The central data receiving and processing server receives the flow information system data and sends it to the data processor 61 of the monitoring system 56. The data processor 61 receives and processes the flow information system data and the flow parameter data entry and any data from the machine learning module 60 to produce a signal maintenance sequence that is sent to the maintenance system 58 to perform predefined automated maintenance actions.

The piping network 24 consists of standard piping systems. Based on standard practices of piping network design which considers the type of working fluid, working pressure of system etc. a suitable pipe material (e.g., HDPE or LDPE) is selected along with the appropriate pressure rating (e.g., PN10, PN16). The dispensing system is fluidly connected to the piping network 24. The dispensing system 28 could be a simple on-off tap, an automated quantity specific device that regulates the amount of liquid dispensed so to limit unnecessary usage or even a central multi-liquid dispenser. The dispensing system 28 could also incorporate a dosing system such as a venturi system (FIG. 6) or mixing valve) that can be used to add user specific liquid preferences (e.g., scent) to the dispensed liquid. The venturi system includes a venturi device 64 in which the base liquid and additive liquid are mixed together to get the mixed liquid product 45. The venturi device 64 and secondary tank 48 containing the additive may be located under the ground 51. In all other aspects, this distribution configuration is similar to that shown in FIG. 1.

The user device 52 may be a mobile device. The mobile device 52 may be any computing device small enough to hold and operate in the hand. The mobile device may comprise a display having LCD flat screen interface that provides a touchscreen interface with digital buttons and keyboard, and/or physical buttons along with a physical keyboard. The mobile device may connect to the internet and interconnect with other devices such as car entertainment systems or headsets via Wi-Fi, Bluetooth, cellular networks or near field communication (NFC). The mobile device 14 may be a cell phone, smart phone, smart watch, tablet, PDA, laptop, notebook or other suitable portable or mobile device. The mobile device 52 may be configured to detect its location and hence the location of a user using the mobile device 52 or other person near the mobile device 52.

The mobile device 52 includes one or more processors and the memory device. The memory device may contain a user identification module that may in turn contain a user identifier and/or user information. The user identifier may be a unique number or code that uniquely identifies the user of the mobile device. The mobile device 52 may also include input/output devices such as a camera capable of taking still or video pictures and have the capability to make video calls. An antenna in the mobile device may send and receive wireless signals from sources such as the radio antenna and satellite. The antenna may, in some implementations, communicate directly with the server such as by exchanging wireless signals. The mobile device 52 may further comprise other input/output devices 52, such as a microphone and a speaker used, for example, in an implementation in which the mobile device 52 functions as a telephone. In some implementations, the mobile device 52 may also include a calendar/clock and a network interface. The calendar/clock may calculate time, date, and other data that can be derived from time data and date data.

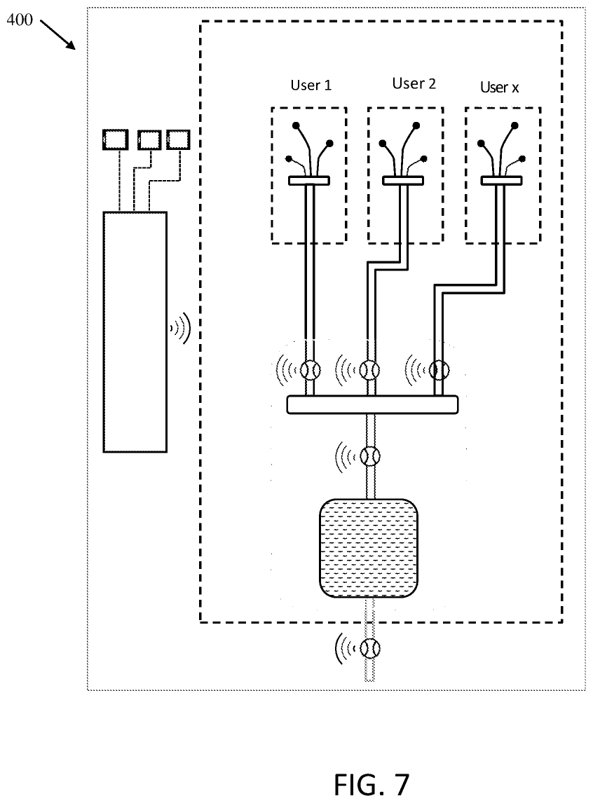

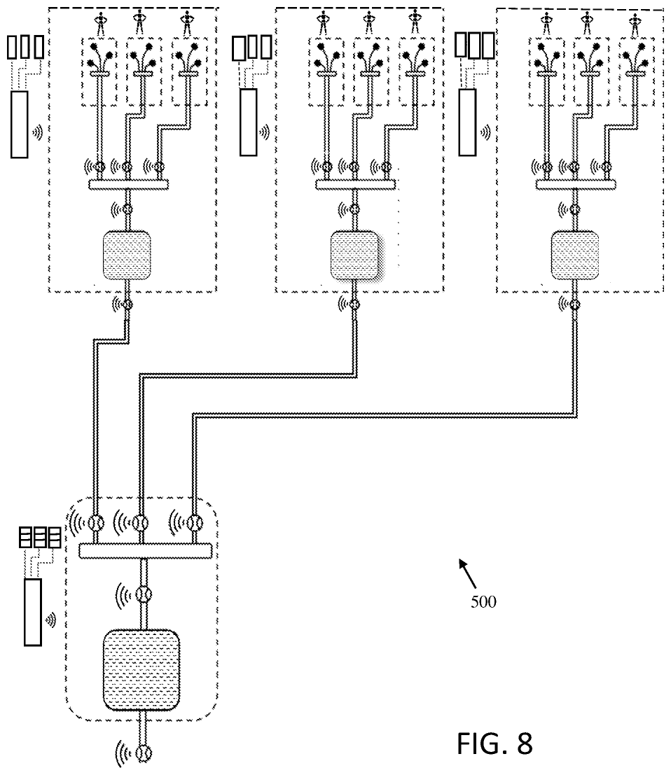

The system 20 is configured to have scalability (i.e., from single user to multi-user applications). Multi-user applications can be further separated into clusters (e.g., apartment or office buildings, neighborhood etc.) to super clusters (e.g., small towns or even entire cities). The benefits of implementing such a solution would scale along with the size (number of users) of the system. Schematics of possible arrangements of the solution for multiple users in a clustered liquid distribution system 400 (FIG. 7) and super clustered liquid distribution system 500 (FIG. 8) arrangements are depicted below. In all other aspects, the distribution configurations of FIGS. 7 and 8 are each similar to that shown in FIG. 1.

Although various embodiments of the disclosed liquid distribution system have been shown and described, modifications may occur to those skilled in the art upon reading the specification. The present application includes such modifications and is limited only by the scope of the claims

What is claimed is:

1. A liquid distribution system comprising:
a central bulk storage station, wherein the central bulk storage station includes a first storage container, wherein the first storage container contains a first liquid, wherein the central bulk storage station includes a second storage container, wherein the second storage container contains a second liquid, wherein the central bulk storage station includes a flow information transmission system;
a piping network, wherein the piping network is fluidly connected to the first and second storage container such that the first and second liquids flow into the piping network and are mixed together in the piping network, wherein the flow information transmission system is in operative connection with the piping network to monitor flow information of the first and second liquid through the piping network;
a central server for receiving and processing data; and
a dispensing system, wherein the dispensing system is fluidly connected to the piping network, wherein the dispensing system is operative to dispense the first and second liquids at one or more dispensing points, wherein the central server is in operative connection with the flow information transmission system, wherein the flow information transmission system is operative to transmit the flow information data of the first and second liquids through one of the dispensing points to the central server, wherein the central server is operative to process the flow information data of the first and second liquids through the one of the dispensing points, wherein the central server is operative to send the processed flow information data of the first and second liquids through the one of the dispensing points to a user device, wherein the user device is operative to output a notification to the user of the first and second liquid consumption from the first and second containers dispensed at the one of the dispensing points based on the processed data.

2. The liquid distribution system of claim 1, wherein the central server includes a billing module, wherein the billing module is operative to receive the first and second liquid consumption data dispensed at the dispensing point and charges a user based on the amount of consumption of the first liquid by the user at the dispensing point.

3. The liquid distribution system of claim 1, wherein the flow information transmission system is in operative connection with the piping network, wherein the flow information transmission system is operative to receive data related to the flow parameters of the piping network, wherein the flow information transmission system sends the received data related to the flow parameters of the piping network to the central server, wherein the central server is operative to process and send the data related to the flow parameters of the piping network to a monitoring system, wherein the monitoring system is operative to determine a fault based on the data related to the flow parameters of the piping network received from the central server.

4. The liquid distribution system of claim 3 further comprising a maintenance system, wherein the monitoring system is in operative connection with the maintenance system, wherein the monitoring system is operative to cause the maintenance system to perform predefined automated maintenance actions based on the fault determined by the monitoring system.

5. The liquid distribution system of claim 4, wherein the monitoring system includes a machine learning module, wherein the machine learning module is operative to perform one or more predictions of one or more possible future faults based on the on the data related to the flow parameters of the piping network received from the central server.

6. The liquid distribution system of claim 1, wherein the first liquid is a consumer liquid necessity, wherein the second liquid is an additive.

7. The liquid distribution system of claim 1, wherein the first and second liquid are mixed together by a venturi device.

8. The liquid distribution system of claim 1 further comprising a pump, wherein the pump is in operative connection with the central bulk storage station, wherein the pump is operative to cause delivery of the liquid from the first and second containers through the piping network.

9. The liquid distribution system of claim 1 further comprising a manifold, wherein the manifold is fluidly connected to the piping network, wherein the manifold is operative to enable the flow of the first and second liquids to multiple dispensing points.

10. The liquid distribution system of claim 1, wherein the flow information transmission system is in operative connection with the first and second containers, wherein the flow transmission system includes a flow tracking device, wherein the flow tracking device is operative to determine the type of liquid being filled in one of the first and second containers.

11. A liquid distribution system comprising:
a central bulk storage station, wherein the central bulk storage station includes a first storage container, wherein the first storage container contains a first liquid, wherein the central bulk storage station includes a flow information transmission system;
a piping network, wherein the piping network is fluidly connected to the first storage container, wherein the flow information transmission system is in operative connection with the piping network to monitor flow information of the first liquid through the piping network;
a central server for receiving and processing data; and
a dispensing system, wherein the dispensing system is fluidly connected to the piping network, wherein the dispensing system is operative to dispense the first liquid at one or more dispensing points, wherein the central server is in operative connection with the flow information transmission system, wherein the flow information transmission system is operative to transmit the flow information data of the first liquid through one of the dispensing points to the central server, wherein the central server is operative to process the flow information data of the first liquid through the one of the dispensing points, wherein the central server is operative to send the processed flow information data of the first liquid through the one of the dispensing points to a user device, wherein the user device is operative to output a notification of the first liquid consumption from the first container dispensed at the one of the dispensing points based on the processed data, wherein the central server includes a billing module, wherein the billing module is operative to receive the first liquid consumption data dispensed at the dispensing point and charges a user based on the amount of consumption of the first liquid by the user at the dispensing point.

12. The liquid distribution system of claim 11 further comprising a manifold, wherein the manifold is fluidly connected to the piping network, wherein the manifold is operative to enable the flow of the first liquid to multiple dispensing points.

13. The liquid distribution system of claim 11, wherein the centrals server is operative to continuously send the processed flow information data of the first liquid through the one of the dispensing points to a user device to enable the user to view the amount of consumption of the first liquid in real time.

14. The liquid distribution system of claim 11, wherein the dispensing system includes a quantity specific device, wherein the quantity specific device is operative to regulate the amount of liquid dispensed at the dispensing point.

15. The liquid distribution system of claim 10, wherein the system is configured to be scalable.

16. A liquid distribution system comprising:
a central bulk storage station, wherein the central bulk storage station includes a first storage container, wherein the first storage container contains a first liquid, wherein the central bulk storage station includes a flow information transmission system;
a piping network wherein the piping network is fluidly connected to the first storage container, wherein the flow information transmission system is in operative connection with the piping network to monitor flow information through the piping network;
a central server for receiving and processing data; and
a dispensing system, wherein the dispensing system is fluidly connected to the piping network, wherein the dispensing system is operative to dispense the first fluid at one or more dispensing points, wherein the central server is in operative connection with the flow information transmission system, wherein the flow information transmission system is operative to receive data related to the flow parameters of the piping network, wherein the flow information transmission system sends the received data related to the flow parameters of the piping network to the central server, wherein the central server is operative to process and send the data related to the flow parameters of the piping network to a monitoring system, wherein the monitoring system is operative to determine a fault based on the data related to the flow parameters of the piping network received from the central server.

17. The liquid distribution system of claim 16 further comprising a maintenance system, wherein the monitoring system is in operative connection with the maintenance system, wherein the monitoring system is operative to cause the maintenance system to perform predefined automated maintenance actions based on the fault determined by the monitoring system.

18. The liquid distribution system of claim 16, wherein the monitoring system includes a machine learning module, wherein the machine learning module is operative to perform one or more predictions of one or more possible future faults based on the on the data related to the flow parameters of the piping network received from the central server.

19. The liquid distribution system of claim 16 further comprising a manifold, wherein the manifold is fluidly connected to the piping network, wherein the manifold is operative to enable the flow of the first liquid to multiple dispensing points.

20. The liquid distribution system of claim 16, wherein the flow information transmission system includes a flow meter.
